(19) United States
(12) Patent Application Publication
(10) Pub. No.: US 2024/0257039 A1
(43) Pub. Date: Aug. 1, 2024

(54) MULTI-THREADING AND PERISHABLE SPLITTING TECHNIQUES IN LOAD AND ROUTE PLANNING

(71) Applicant: Walmart Apollo, LLC, Bentonville, AR (US)

(72) Inventors: Xiaojie Wang, Redmond, WA (US); Ou Sun, Rancho Santa Margarita, CA (US); Ti Zhang, Rocklin, CA (US); Jing Huang, San Jose, CA (US); Mingang Fu, Palo Alto, CA (US)

(73) Assignee: Walmart Apollo, LLC, Bentonville, AR (US)

(21) Appl. No.: 18/103,325

(22) Filed: Jan. 30, 2023

(51) Int. Cl. G06Q 10/0835; G06Q 10/0832

(52) U.S. Cl. CPC G06Q 10/08355; G06Q 10/047; G06Q 10/0832

(57) ABSTRACT

A system comprising one or more processors; and one or more non-transitory computer-readable media storing computing instructions, that when executed on the one or more processors, cause the one or more processors to perform functions comprising: obtaining a route plan for outbound transport from a distribution center; processing multiple threads in parallel to obtain multiple improvements to the route plan, where each of the multiple threads customizes the route plan using one or more different parameters; selecting a lowest cost route solution from the multiple improvements to the route plan; and using the lowest cost route solution for the outbound transport from the distribution center. Other embodiments are disclosed.

### TECHNICAL FIELD

This disclosure relates generally to multi-threading and perishable splitting techniques in load and route planning.

### BACKGROUND

Building routing and loading plans for outbound routes for different trailer types from a distribution center can lead to increased transportation costs using conventional approaches.

### BRIEF DESCRIPTION OF THE DRAWINGS

To facilitate further description of the embodiments, the following drawings are provided in which:

FIG. 1 illustrates a front elevational view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a block diagram of a multi-threading route planner system for automatic generation of an outbound route and load plan using a multi-threading framework, according to an embodiment;

FIG. 4 illustrates a block diagram for a method of acts, modules, and outputs, for automatic generation of a load plan and a route plan, according to an embodiment;

FIG. 5 illustrates a flow chart for a method of processing, using a routing optimizer, multiple threads in parallel, according to an embodiment;

FIG. 6 illustrates a flow chart for a method of automatically building a multi-threading framework for outbound route and load plans, according to another embodiment; and

FIG. 7 illustrates a flow chart for an exemplary method of processing, using a routing optimizer, multiple threads in parallel.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc, in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

### Description of Examples of Embodiments

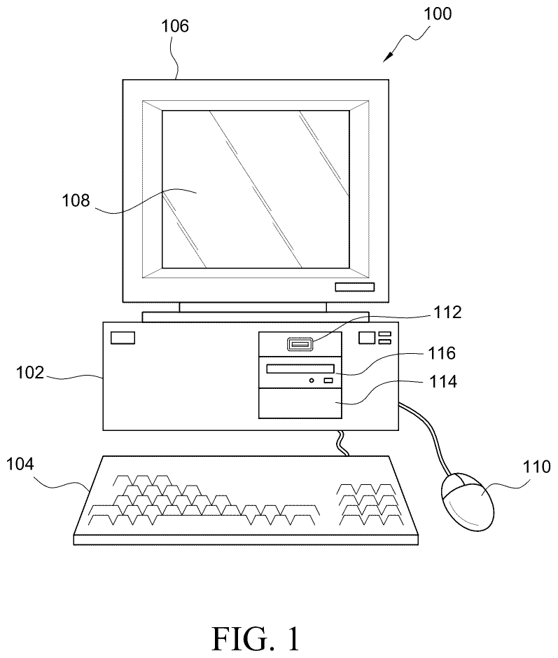

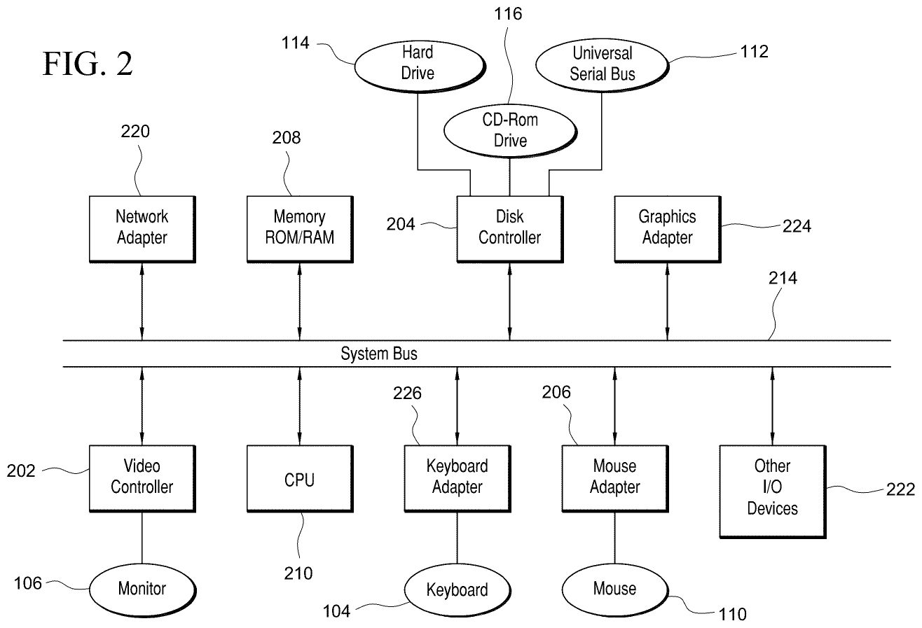

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2). Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can include one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS. Further exemplary operating systems can comprise one of the following: (i) the iOS® operating system by Apple Inc. of Cupertino, California, United States of America, (ii) the Blackberry® operating system by Research In Motion (RIM) of Waterloo, Ontario, Canada, (iii) the WebOS operating system by LG Electronics of Seoul, South Korea, (iv) the Android™ operating system developed by Google, of Mountain View, California, United States of America, (v) the Windows Mobile™ operating system by Microsoft Corp. of Redmond, Washington, United States of America, or (vi) the Symbian™ operating system by Accenture PLC of Dublin, Ireland.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 1) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer. For purposes of illustration, programs and other executable program components are shown herein as discrete systems, although it is understood that such programs and components may reside at various times in different storage components of computer system 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

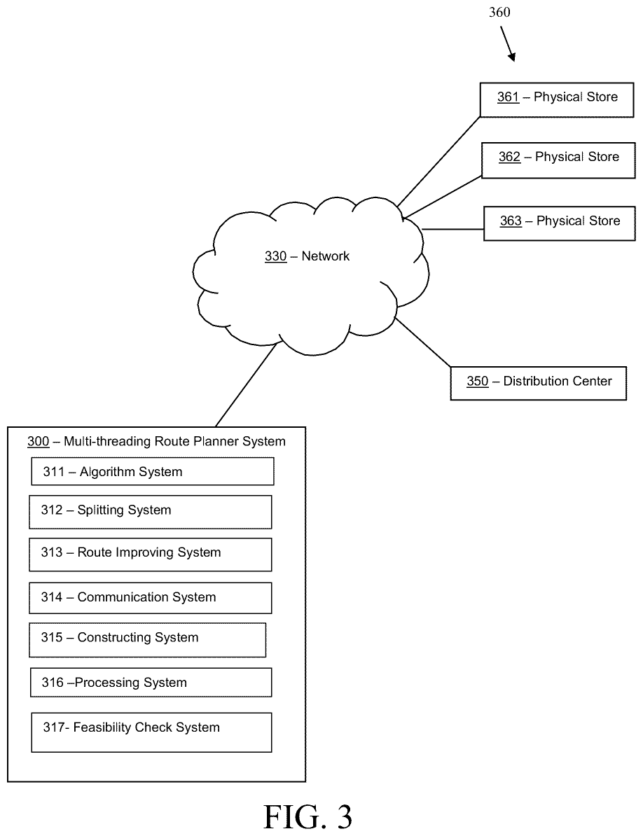

Turning ahead in the drawings, FIG. 3 illustrates a block diagram of a multi-threading route planner system 300 for automatic generation of an outbound route and load plan using a multi-threading framework, according to an embodiment. Multi-threading route planner system 300 is merely exemplary and embodiments of the system are not limited to the embodiments presented herein. Multi-threading route planner system 300 can be employed in many different embodiments or examples not specifically depicted or described herein. In some embodiments, certain elements, modules, or systems of multi-threading route planner system 300 can perform various procedures, processes, and/or activities. In other embodiments, the procedures, processes, and/or activities can be performed by other suitable elements, modules, or systems of multi-threading route planner system 300. Multi-threading route planner system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of multi-threading route planner system 300 described herein.

In many embodiments, multi-threading route planner system 300 can be a computer system, such as computer system 100 (FIG. 1), as described above, and can each be a single computer, a single server, or a cluster or collection of computers or servers, or a cloud of computers or servers. In another embodiment, a single computer system can host multi-threading route planner system 300. Additional details regarding multi-threading route planner system 300 are described herein.

In some embodiments, multi-threading route planner system 300 can be in data communication through a network 330 with physical stores 360, which can include physical stores 361-363, for example, and distribution centers, such as distribution center 350. In several embodiments, each of the physical stores (e.g., 360) and each of the distribution centers (e.g., 350) can be a physical, brick-and-mortar location that are associated (e.g., operated by a common business entity or entities under common control) with multi-threading route planner system 300. In many embodiments, the physical stores (e.g., 360) and the distribution centers (e.g., 350) each can include one or more computer systems.

In a number of embodiments, each of physical stores 360 can be a retail store, such as a department store, a grocery store, or a super store (e.g., both a grocery store and a department store). In many embodiments, the distribution centers (e.g., 350) can provide the items sold at the physical stores (e.g., 360). For example, a distribution center (e.g., 350) can supply and/or replenish stock at the physical stores (e.g., 360) that are in a region of the distribution center. In many embodiments, a physical store (e.g., 361-363) can submit an order to a distribution center (e.g., 350) to supply and/or replenish stock at the physical store (e.g., 361-363). In many embodiments, distribution center 350 can be referred to as a warehouse or other facility that does not sell products directly to a customer.

In some embodiments, multi-threading route planner system 300 can be a distributed system that includes one or more systems in each of the distribution centers (e.g., 350). In other embodiments, multi-threading route planner system 300 can be a centralized system that communicates with computer systems in the physical stores (e.g., 360) and distribution centers (e.g., 350). In some embodiments, network 330 can be an internal network that is not open to the public, which can be used for communications between multi-threading route planner system 300, physical stores (e.g., 360), and distribution centers (e.g., 350). In other embodiments, network 330 can be a public network, such as the Internet. In several embodiments, operators and/or administrators of multi-threading route planner system 300 can manage multi-threading route planner system 300, the processor(s) of multi-threading route planner system 300, and/or the memory storage unit(s) of multi-threading route planner system 300 using the input device(s) and/or display device(s) of multi-threading route planner system 300, or portions thereof in each case.

In several embodiments, multi-threading route planner system 300 can include one or more input devices (e.g., one or more keyboards, one or more keypads, one or more pointing devices such as a computer mouse or computer mice, one or more touchscreen displays, a microphone, etc.), and/or can each include one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to multi-threading route planner system 300 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of multi-threading route planner system 300. In a similar manner, the processors and/or the non-transitory computer-readable media can be local and/or remote to each other.

Meanwhile, in many embodiments, multi-threading route planner system 300 also can be configured to communicate with and/or include one or more databases. The one or more databases can include a product database that contains information about products, items, or SKUs (stock keeping units), for example, among other data as described herein, such as described herein in further detail. The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, communication between multi-threading route planner system 300, physical stores 360, distribution center 350, and/or the one or more databases can be implemented using any suitable manner of wired and/or wireless communication. Accordingly, multi-threading route planner system 300 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

Exemplary mobile devices can include (i) an iPod®, iPhone®, iTouch®, iPad®, MacBook® or similar product by Apple Inc. of Cupertino, California, United States of America, (ii) a Blackberry® or similar product by Research in Motion (RIM) of Waterloo, Ontario, Canada, (iii) a Lumia® or similar product by the Nokia Corporation of Keilaniemi, Espoo, Finland, and/or (iv) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, California, United States of America, (ii) the Blackberry® operating system by Research In Motion (RIM) of Waterloo, Ontario, Canada, (iii) the Palm® operating system by Palm, Inc. of Sunnyvale, California, United States, (iv) the Android™ operating system developed by the Open Handset Alliance, (v) the Windows Mobile™ operating system by Microsoft Corp. of Redmond, Washington, United States of America, or (vi) the Symbian™ operating system by Nokia Corp. of Keilaniemi, Espoo, Finland.

Further still, the term “wearable user computer device” as used herein can refer to an electronic device with the capability to present audio and/or visual data (e.g., text, images, videos, music, etc.) that is configured to be worn by a user and/or mountable (e.g., fixed) on the user of the wearable user computer device (e.g., sometimes under or over clothing; and/or sometimes integrated with and/or as clothing and/or another accessory, such as, for example, a hat, eyeglasses, a wrist watch, shoes, etc.). In many examples, a wearable user computer device can include a mobile device, and vice versa. However, a wearable user computer device does not necessarily include a mobile device, and vice versa.

In many embodiments, multi-threading route planner system 300 can include a algorithm system 311, a splitting system 312, a route improving system 313, a communication system 314, a constructing system 315, a processing system 316, and/or a feasibility check system 317. In many embodiments, the systems of multi-threading route planner system 300 can be modules of computing instructions (e.g., software modules) stored at non-transitory computer readable media that operate on one or more processors. In other embodiments, the systems of multi-threading route planner system 300 can be implemented in hardware. Multi-threading route planner system 300 can be a computer system, such as computer system 100 (FIG. 1), as described above, and can be a single computer, a single server, or a cluster or collection of computers or servers, or a cloud of computers or servers. In another embodiment, a single computer system can host multi-threading route planner system 300. Additional details regarding multi-threading route planner system 300 and the components thereof are described herein.

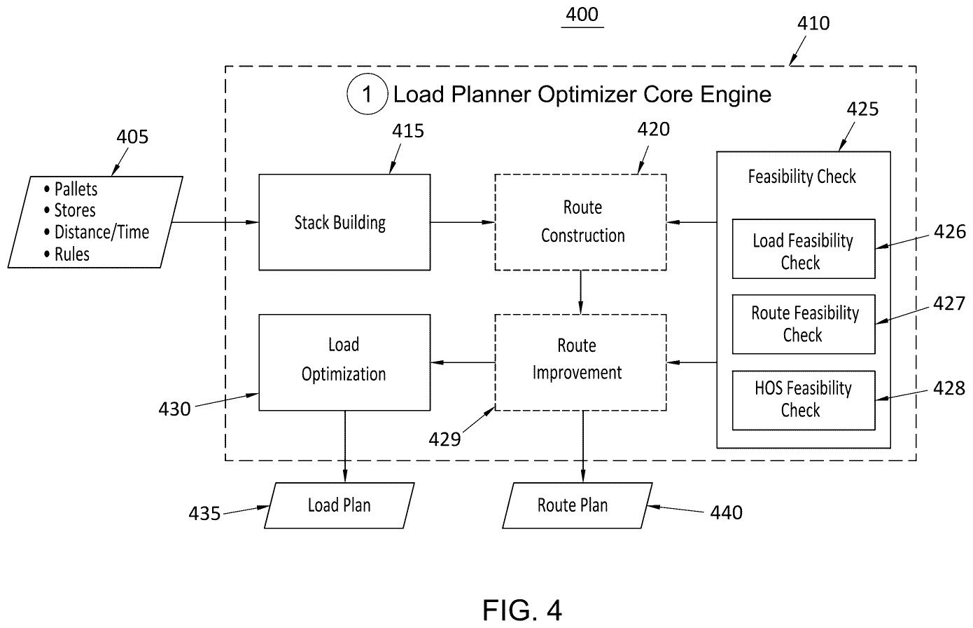

Turning ahead in the drawings, FIG. 4 illustrates a block diagram for a method 400 of acts, modules, and outputs, for automatic generation of a load plan and a route plan, according to an embodiment. The automatic generation of a load plan and a route plan can be similar or identical to the automatic generation of load and route design and activities shown and described in U.S. patent application Ser. No. 16/777,498, filed Jan. 30, 2020, (referred to herein as the “498 Patent Application”), and the '498 Patent Application is incorporated herein by reference in its entirety. Various activities associated with method 400 can be similar or identical to various activities described in the '498 Patent Application. In several embodiments, method 400 can be employed in many different embodiments or examples not specifically depicted or described herein. In a number of embodiments, certain elements of method 400 can perform, involve, and/or be generated by various procedures, processes, and/or activities. In a number of embodiments, certain elements of method 400 can perform, involve, and/or be generated by various procedures, processes, and/or activities. In other embodiments, the procedures, processes, and/or activities can be performed by, and the outputs can be generated by, other suitable elements of method 400. In many embodiments, method 400 can be implemented by multi-threading route planner system 300 (FIG. 3).

In several embodiments, method 400 can include a block 405 of receiving input parameters for that can be used in generating a load plan. In many embodiments, block 405 of receiving input parameters also can be used to generate a route plan to deliver pallets of goods or items of orders to predetermined destinations in a predetermined order. Such a load plan can be similar or identical to the load plan output in block 435 and such a route plan can be similar or identical to the route plan output in block 440, each as further described below. In various embodiments, block 405 of input parameters can include store pallets with various commodities (e.g., goods, items) order by a store, a distribution center (DC), and/or another suitable entity. In some embodiments, other input parameters can include a sequence of routes and/or stops in a route plan where each order for a respective store is transported and delivered on the route plan. Such input parameters can include a distance and a transportation time from a DC to each stop in between and a return time back to a DC. In various embodiments, block 405 further can include pallet parameters: a) length, width, height, and/or weight, b) pallet attributes for temperature constraints (e.g., frozen, refrigeration, and/or dry pallets), c) stacking rules such for each store, trailer axle distribution, and/or other suitable stacking rules, d) dimension and configuration of trailers including dry trailers, temperature controlled trailers, tri-temperature trailers, and/or another suitable trailer configuration, e) loading rules, and f) driving rules enforced by the Department of Transportation (DOT), such as the DOT regulations promulgated in Title 49, U.S. Code of Federal Regulations, Parts 300-399 and/or another suitable regulation and/or another suitable loading rule. In many embodiments, method 400 can proceed after block 405 to a block 410.

In some embodiments, method 400 can include block 410 of utilizing a load planner optimizer core engine to generate a load plan and a route plan. In several embodiments, load plan and route plan can be similar or identical to the activities described in block 435 and block 440. In several embodiments, block 410 can include can include various acts, modules, and outputs which can include a block 415 of building stacks, block 420 of constructing a route, block 425 of running a feasibility check on each route, block 445 of improving the route after the each feasibility check, block 450 of optimizing the load, block 460 of outputting the route plan, and/or block 455 of outputting a load plan. Method 400 can proceed after block 410 to block 415.

In various embodiments, method 400 can include block 415 of building stacks of pallets based on a number of orders for delivery to another location or destination, such as a store or a DC. In some embodiments, block 415 can include building store stacks where each stack includes one or more pallets transport to each store. In several embodiments, block 415 also can build or optimize stacks of pallets that are load feasible. In some embodiments, a load feasible plan can be in compliance with rules, regulations, vehicle constraints, and Department of Transportation restrictions. In various embodiments, building stacks (e.g., stack building) of pallets can include a loading design. In many embodiments, such a loading design can include designing a load plan for a tractor-trailer vehicle with two axles and a trailer that can carry dry items or goods and/or a tri-temperature trailer that can carry frozen or refrigerated items or goods. In several embodiments, method 400 can proceed after block 415 to a block 420.

In various embodiments, method 400 can include block 420 of constructing a route plan based on orders for delivery to another location. Such locations can include a DC, a Store location, and/or another suitable delivery location. In several embodiments, block 420 of constructing a route plan for a delivery can include a sequence or series of delivery stops that can influence the way in which a load plan is designed to include an ordered sequence of loading the trailer by store stops and/or accommodating floor space with frozen or refrigerated bulkhead sections of a temperature-controlled trailer. In some embodiments, method 400 can proceed after block 420 to a block 425.

In a number of embodiments, method 400 can include block 425 of implementing multiple feasibility checks on a current route design. In several embodiments, multiple feasibility checks can be run on route plans constructed in block 420 and/or improved or updated route plans modified in block 429. In some embodiments, block 425 can include multiple feasibility checks such as load feasibility check (block 426), route feasibility check (block 427), and/or Hours of Service (HOS) feasibility check (block 428). The load feasibility check and the route feasibility check can be similar or identical to the enhanced load feasibility check and the route feasibility check activities shown and described in U.S. patent application Ser. No. 17/163,428, filed Jan. 30, 2021, (referred to herein as the “428 Patent Application”), and the '428 Patent Application is incorporated herein by reference in its entirety. Various activities associated with block 425 can be similar or identical to various activities described in the '428 Patent Application and/or the '498 Patent Application. In various embodiments, method 400 can proceed after block 425 to a block 429.

In some embodiments, method 400 can include block 429 of generating an improvement to a route plan (e.g., route) using the output of the feasibility checks in block 425. In many embodiments, block 429 can include running a second feasibility check in an improved or updated route plan. In various embodiments, running the second feasibility check can be run in parallel with multiple threads via the multi-threading route planner system. In several embodiments, method 400 can proceed after block 429 to a block 430 and/or a block 440.

In a number of embodiments, method 400 can include block 440 of outputting a route plan based on the reconfigured route plan output from block 429.

In several embodiments, method 400 can include block 430 of optimizing a load after incorporating the reconfigured route plan with improvements of block 429. In various embodiments, load optimization follows loading rules in generating feasible load plans. In some embodiments, loading rules can include conditions or restrictions for each loading design or load such as, 1) trailer dimension requirements, 2) axle weight limitations, 3) curbside and/or road weight balance requirements, and 4) minimizing unnecessary unloading of stacks in the load design. In many embodiments, method 400 can proceed after block 430 to a block 435.

In various embodiments, method 400 can include block 435 of outputting an original load plan and/or a reconfigured load plan as output by the activities of block 410.

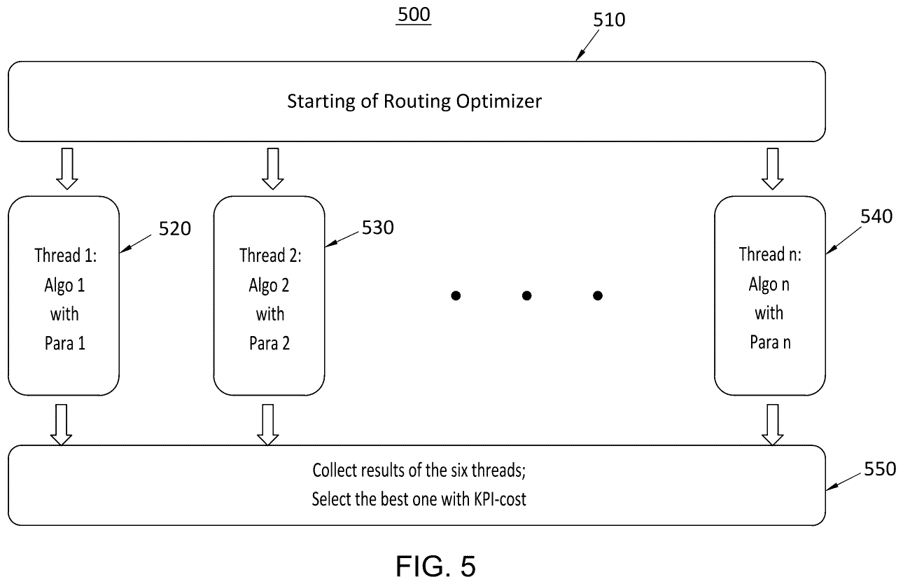

Jumping ahead in the drawings, FIG. 5 illustrates a flow chart for a method 500 of processing, using a routing optimizer, multiple threads in parallel, according to an embodiment. Method 500 also can build a multi-threading framework for outbound route plans and load plans. Method 500 can be employed in many different embodiments and/or examples not specifically depicted or described herein. In some embodiments, the procedures, the processes, and/or the activities of method 500 can be performed in the order presented or in parallel. In other embodiments, the procedures, the processes, and/or the activities of method 500 can be performed in any suitable order. In still other embodiments, one or more of the procedures, the processes, and/or the activities of method 500 can be combined or skipped. In several embodiments, system 300 (FIG. 3) can be suitable to perform method 500 and/or one or more of the activities of method 500.

In these or other embodiments, one or more of the activities of method 500 can be implemented as one or more computing instructions configured to run at one or more processors and configured to be stored at one or more non-transitory computer-readable media. Such non-transitory computer-readable media can be part of a computer system such as multi-threading route planner system 300. The processor(s) can be similar or identical to the processor(s) described above with respect to computer system 100 (FIG. 1).

In several embodiments, method 500 can include a block 510 of inputting a number of threads into the optimizer algorithm to process each thread of the multiple threads in parallel. In some embodiments, the optimizer algorithm of the multi-threading route planner system (e.g., framework) can include running different algorithms in each stage of determining an outbound route plan. In many embodiments, constructing an outbound route plan can include two stages of constructing the initial route plan and improving the initial route plan by implementing different algorithms in each stage: (i) a route construction algorithm and (ii) a route improvement algorithm. In many embodiments, route construction can be similar or identical to the activities described above in block 420 (FIG. 4). In some embodiments, route improvement can be similar or identical to the activities described above in block 429 (FIG. 4). Method 500 can proceed after block 510 to a block 520, a block 530, and a block 540.

In some embodiments, method 500 can include a predetermined number of threads of the multiple threading route planner system run in parallel, such threads are represented as block 520, block 530, and block 540 for illustration purposes in FIG. 5. In several embodiments, method 500 can include block 520 of running a first thread of an “n” number of multiple threads in parallel based on algorithm 1 and parameters 1. In various embodiments, method 500 can include block 530 of running a second thread of an “n” number of multiple threads in parallel based on algorithm 2 and parameters 2. In several embodiments, method 500 can include block 540 of running the last thread of an “n” number of multiple threads in parallel based on algorithm n and parameters n.

In various embodiments, the predetermined number of threads can be a configurable number. In some embodiments, based on experimental results, the configurable number “n” can be n=6. In several embodiments, each thread can be designed to run different sets of parameters with a different algorithm matching the current stage of the route plan and load plan (e.g., create route plan or create load plan) in parallel. In various embodiments, each thread run in parallel can produce or output a respective route plan and load plan with a respective cost solution and/or key performance indicator (KPI) cost solution. In several embodiments, KPI cost solutions for a route plan and a load plan can include multiple costs as factors associated with miles travelled, number of routes (e.g., stops), duration of drive time and/or the amount of time to complete the route, and/or another suitable KPI factor.

In some embodiments, method 500 also can run multiple feasibility checks for each stage of the route plan and load plan as part of the same thread of the multiple threading route planner system. Such feasibility checks can include a load feasibility check, a route feasibility check and/or an HOS feasibility check. In many embodiments, feasibility checks can be similar or identical to the activities described above in block 425, block 426, block 427, and/or block 428 (FIG. 4). In several embodiments, method 500 also can include selecting, using the multiple threading route planner system, each thread criteria (e.g., 2 criteria) in either stage of route construction and/or load construction, such as create route plan or create load plan. In some embodiments, method 500 can proceed after blocks 520, 530, and 540 to a block 550.

In a number of embodiments, method 500 can include block 550 of selecting the lowest cost solution output from the multi-threading process. In some embodiments, block 550 can include collecting the output of the number of multiple threads run in parallel to create a list of cost solutions or KPI cost solutions. In several embodiments, block 550 also can include sorting each of the outputs of the multiple threads by a cost route solution from lowest cost to highest cost.

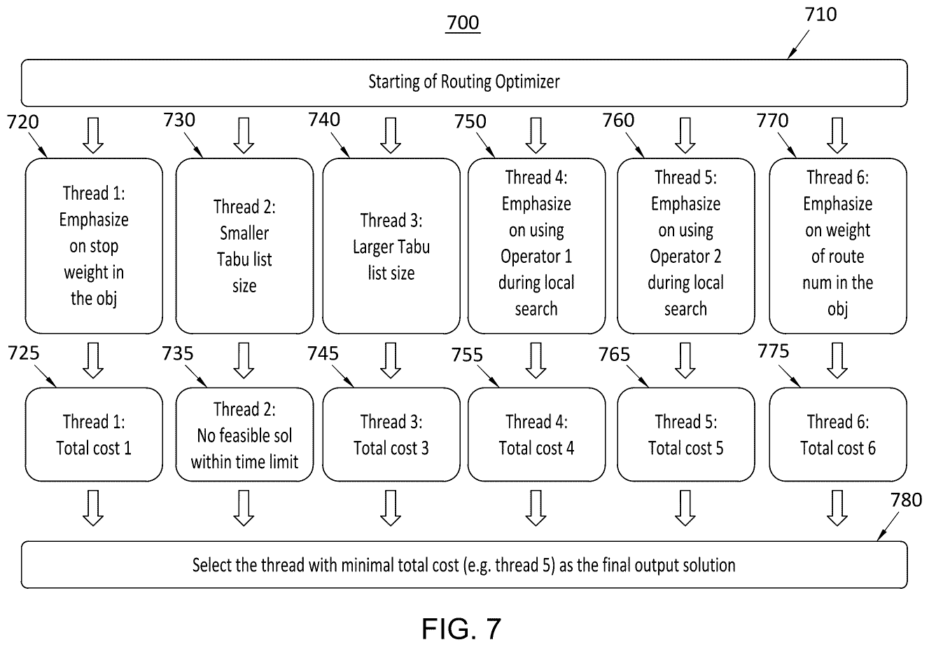

Jumping ahead in the drawings, FIG. 7 illustrates a flow chart for an exemplary method 700 of processing, using a routing optimizer, multiple threads in parallel. Similar to method 500 above, method 700 begins with an activity 710 of starting a route optimizer using six threads to process in parallel. Each algorithm in each thread runs a respective approach to determine a respective output of a KPI cost solution in parallel. Method 700 illustrates how each thread processes different exemplary approaches using a respective algorithm to output a total cost for each thread. For example, a thread 1 can include activity 720 and activity 725 of outputting a total cost. In this example, activity 720 includes emphasizing a stop weight in the objective as input used a respective algorithm of thread 1. Activity 725 can include outputting a cost solution as output for thread 1 after running thread 1 in parallel processing, using a routing optimizer, multiple threads in parallel.

Additionally, a thread 2 can include an activity 730 of using a smaller Tabu list size as input. In this example, thread 2 can include an activity 735 of outputting a total cost returned as a null output for thread 2 as no feasible solution was found within the time limit run for the respective algorithm. Thus, the final output solution can be calculated based on five threads instead of six threads.

Also, thread 3 includes an activity 740 of using a larger Tabu list size as input, and an activity 745 of outputting a total cost. Additionally, thread 4 includes an activity 750 with emphasizing using operator 1 during a local search, and an activity 755 of outputting a total cost.

Also, thread 5 includes an activity 760 of emphasizing using operator-2 during a local search, and an activity 755 of outputting a total cost.

Additionally, thread 6 includes an activity 770 of emphasizing the weight of the route number in the objective, and an activity 775 of outputting a total cost. Method 700 also can include an activity 780 of selecting of a thread that returned the lowest cost solution from the multi-threading process run in parallel, based on the outputs from activities 725, 735, 745, 755, 765, and 775.

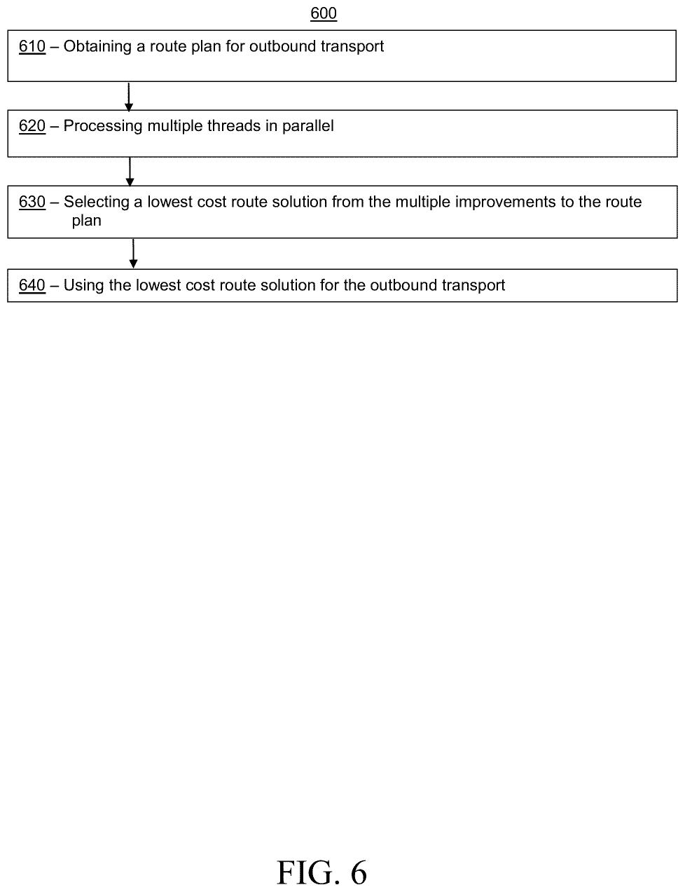

Turning back in the drawings, FIG. 6 illustrates a flow chart for a method 600 of automatically building a multi-threading framework for outbound route and load plans, according to another embodiment. Method 600 is merely exemplary and is not limited to the embodiments presented herein. Method 600 can be employed in many different embodiments and/or examples not specifically depicted or described herein. In some embodiments, the procedures, the processes, and/or the activities of method 600 can be performed in the order presented. In other embodiments, the procedures, the processes, and/or the activities of method 600 can be performed in any suitable order. In still other embodiments, one or more of the procedures, the processes, and/or the activities of method 600 can be combined or skipped. In several embodiments, multi-threading route planner system 300 (FIG. 3) can be suitable to perform method 600 and/or one or more of the activities of method 600.

In these or other embodiments, one or more of the activities of method 600 can be implemented as one or more computing instructions configured to run at one or more processors and configured to be stored at one or more non-transitory computer-readable media. Such non-transitory computer-readable media can be part of a computer system such as multi-threading route planner system 300 (FIG. 3). The processor(s) can be similar or identical to the processor(s) described above with respect to computer system 100 (FIG. 1).

Referring to the drawings in FIG. 6, method 600 can include a block 610 of obtaining a route plan for outbound transport from a distribution center. In various embodiments, the route plan and the load plan can be built or designed for a respective trailer type. In various embodiments, obtaining a route plan for outbound transport can be designed differently for a respective trailer type: (i) a dry trailer and a (ii) temperature dependent trailer.

In some embodiments, block 610 also can include constructing the route plan for a dry trailer based on a loading plan. In various embodiments, constructing the route plan for a dry trailer can include using a route improvement algorithm. In several embodiments, constructing the route plan for the dry trailer based on the loading plan can include constructing the multiple improvements to the route plan for the dry trailer using the one or more different parameters for each of the multiple threads. In some embodiments, block 610 selects the different parameters for each thread based on respective parameters of: (i) a respective algorithm used, (ii) options in initial solution construction, and (iii) input parameters. Selecting the different parameters can be similar or identical to the activities of blocks 720, 730, 740, 750, 760, and/or 770 (FIG. 7).

In various embodiments, block 610 further can include constructing the route plan for a temperature-controlled trailer based on a loading plan for orders. In several, embodiments, the orders can include refrigerated pallets and frozen pallets.

In some embodiments, constructing the route plan for the temperature-controlled trailer also can include splitting each of the orders according to a temperature range for transport in the temperature-controlled trailer.

In several embodiments, constructing the route plan for the temperature-controlled trailer further can include constructing, using a greedy heuristic, the route plan for the temperature-controlled trailer. In many embodiments, method 600 can proceed after block 610 to a block 620.

In a number of embodiments, method 600 can include a block 620 of processing multiple threads in parallel to obtain multiple improvements to the route plan. In some embodiments, each route plan can be for a respective dry trailer. In various embodiments, each respective dry trailer can include respective dimensions, bulkheads, volume, height, axles, and/or another suitable factor for a trailer. In several embodiments, block 620 each of the multiple threads can be customized for the route plan using one or more different parameters. In many embodiments, block 620 can be similar or identical to block 520, block 530, block 540, and/or block 550 (FIG. 5).

In some embodiments, block 620 further can include using a metaheuristic search method comprising a Tabu search.

In various embodiments, block 620 additionally can include processing the multiple threads for a dry trailer to obtain the multiple improvements to the route plan also can include splitting, using a Tabu search, the one or more different parameters for each of the multiple threads. In many embodiments, block 620 can be similar or identical to the activities described above in block 520, block 530, block 540, and/or block 550 (FIG. 5).

In several embodiments, block 620 further can include processing the multiple threads to obtain the multiple improvements to the route plan further can include tuning, by the Tabu search, the one or more different parameters for each of the multiple threads by varying a Tabu list size. In some embodiments, processing the multiple threads can include generating different threads with different Tabu parameter tuning based on different respective operator probability tuning, such as: (i) Tabu one-one, Tabu one-zero, Tabu two-opt. In many embodiments, block 620 can be similar or identical to the activities described above in block 429 (FIG. 4) and/or block 520, block 530, block 540, and/or block 550 (FIG. 5).

In several embodiments, the one or more different parameters can include at least one of (i) a weight of miles, (ii) a weight of routes, and/or (iii) a weight of stops. In some embodiments the one or more different parameters can be based on a dry trailer. In various embodiments, multi-threading of the multiple threads can be configurable by varying a cost-profile using an objective function. In many embodiments, block 620 can be similar or identical to the activities described above in block 405 (FIG. 4) and/or block 510 (FIG. 5).

In a number of embodiments, block 620 also can include processing the multiple threads to obtain the multiple improvements to the route plan also can include constructing the multiple improvements to the route plan for the temperature-controlled trailer using the one or more different parameters for each of the multiple threads. In various embodiments, constructing the route plan for a temperature-controlled trailer can include using a greedy heuristic algorithm. In various embodiments, each respective temperature-controlled trailer can include respective dimensions, temperature-controlled bulkheads, dry bulkheads, volume, height, axles, and/or another suitable factor for a temperature-controlled trailer.

In many embodiments, block 620 also can include processing the multiple threads to obtain the multiple improvements to the route plan additionally can include splitting, using a Tabu search, the one or more different parameters for each of the multiple threads. In several embodiments, block 620 further can include processing the multiple threads can be for a respective temperature-controlled trailer. In various embodiments, processing the multiple threads can include using a route improvement algorithm for temperature-controlled trailers. In several embodiments, splitting can include an order split for each stop (e.g., activity or delivery) along each route plan, where each active split of the order (e.g., pallets) can be made according respective temperatures splits.

In various embodiments, processing the multiple threads to obtain the multiple improvements to the route plan further can include tuning, by the Tabu search, the one or more different parameters for each of the multiple threads by varying a Tabu list size. Similar to dry trailers, processing the multiple threads can include generating different threads with different Tabu parameter tuning based on different respective operator probability tuning, such as: (i) Tabu one-one, Tabu one-zero, Tabu two-opt.

In several embodiments, the one or more different parameters for the temperature-controlled trailer can include at least one of (i) a weight of miles, (ii) a weight of routes, and/or (iii) a weight of stops. In some embodiments the one or more different parameters can be based on a respective temperature-controlled trailer. In various embodiments, multi-threading of the multiple threads for a temperature-controlled can be configurable by varying a cost-profile using an objective function. In many embodiments, method 600 can proceed after block 620 to a block 630.

In a number of embodiments, method 600 additionally can include block 630 of selecting a lowest cost route solution from the multiple improvements to the route plan. In many embodiments, block 630 can be similar or identical to the activities described above in block 440 (FIG. 4) and/or block 550 (FIG. 5).

In various embodiments, block 630 of selecting the lowest cost route solution also can include conducting multiple feasibility checks for each of the multiple improvements to the route plan. In some embodiments, the multiple feasibility checks can include: (i) a load feasibility check, (ii) a route feasibility check, and (iii) an hours of service (HOS) feasibility check. In several embodiments, block 630 can be similar or identical to the activities described above in block 425 (FIG. 4). In many embodiments, method 600 can proceed after block 630 to a block 640.

In various embodiments, method 600 also can include block 640 of using the lowest cost route solution for the outbound transport from the distribution center. For example, the lowest cost route solution can be used for physically loading the trailers with the pallets and routing the trailers for transporting from the distribution center to the physical stores.

Returning to FIG. 3, in a number of embodiments, algorithm system 311 can at least partially perform block 510 (FIG. 5) of inputting a number of threads into the optimizer algorithm to process each thread of the multiple threads in parallel.

In some embodiments, splitting system 312 can at least partially perform block 620 (FIG. 6) additionally can include processing the multiple threads for a dry trailer to obtain the multiple improvements to the route plan also can include splitting, using a Tabu search, the one or more different parameters for each of the multiple threads.

In several embodiments, route improving system 313 can at least partially perform block 429 (FIG. 4) of generating an improvement to a route plan (e.g., route) using the output of the feasibility checks in block 425 (FIG. 4), block 430 (FIG. 4) of optimizing a load after incorporating the reconfigured route plan with improvements of block 429 (FIG. 4), block 435 (FIG. 4) of outputting an original load plan and/or a reconfigured load plan as output by the activities of block 410, block 440 (FIG. 4) of outputting a route plan based on the reconfigured route plan output from block 429 (FIG. 4), block 550 (FIG. 5) of selecting the lowest cost solution output from the multi-threading process, block 610 (FIG. 6) of constructing the route plan for the dry trailer based on the loading plan includes constructing the multiple improvements to the route plan for the dry trailer using the one or more different parameters for each of the multiple threads, block 610 (FIG. 6) further can include constructing the route plan for a temperature-controlled trailer based on a loading plan for orders, block 630 (FIG. 6) of selecting a lowest cost route solution from the multiple improvements to the route plan, and/or block 640 (FIG. 6) of using the lowest cost route solution for the outbound transport from the distribution center.

In many embodiments, communication system 314 can at least partially perform block 550 (FIG. 5) of selecting the lowest cost solution output from the multi-threading process, and/or block 640 (FIG. 6) of using the lowest cost route solution for the outbound transport from the distribution center

In various embodiments, constructing system 315 can at least partially perform block 405 (FIG. 4) of receiving input parameters for that can be used in generating a load plan, block 410 (FIG. 4) of utilizing a load planner optimizer core engine to generate a load plan and a route plan, block 415 (FIG. 4) of building stacks of pallets based on a number of orders for delivery to another location or destination, such as a store or a DC, block 420 (FIG. 4) of constructing a route plan based on orders for delivery to another location, and/or block 610 (FIG. 6) of obtaining a route plan for outbound transport from a distribution center.

In some embodiments, processing system 316 can at least partially perform block 520 (FIG. 5) of running a first thread of an “n” number of multiple threads in parallel based on algorithm 1 and parameters 1, block 530 (FIG. 5) of running a second thread of an “n” number of multiple threads in parallel based on algorithm 2 and parameters 2, block 540 (FIG. 5) of running the last thread of an “n” number of multiple threads in parallel based on algorithm n and parameters n, block 620 (FIG. 6) of processing multiple threads in parallel to obtain multiple improvements to the route plan, block 620 (FIG. 6) further can include using a metaheuristic search method comprising a Tabu search, block 620 (FIG. 6) additionally can include processing the multiple threads for a dry trailer to obtain the multiple improvements to the route plan also can include splitting, using a Tabu search, the one or more different parameters for each of the multiple threads, and/or block 620 (FIG. 6) also can include processing the multiple threads to obtain the multiple improvements to the route plan also can include constructing the multiple improvements to the route plan for the temperature-controlled trailer using the one or more different parameters for each of the multiple threads.

In various embodiments, feasibility check system 317 can at least partially perform block 425 (FIG. 4) of implementing multiple feasibility checks on a current route design.

In many embodiments, the techniques described herein can be used continuously at a scale that cannot be handled using manual techniques. For example, the number of daily and/or monthly visits to a website can exceed approximately ten million and/or other suitable numbers, the number of products and/or items sold on the website can exceed approximately ten million (10,000,000) approximately each day and/or the number of orders to be transported to stores can exceed approximately one million (1,000,000) each day.

In some embodiments, another advantage of using multi-threading route planner system over conventional approaches (e.g., mixed integer) can be illustrated by: (i) running multiple threads in parallel using different algorithms and different parameters generates multiple cost solutions at the same time and (ii) tuning, with Tabu, the one or more different parameters allows for faster convergence. In many embodiments, multi-threading route planner can minimize and reduce transportation costs as measured by routes, miles, etc. by obtaining a multiple number of cost solutions where any of the cost solutions can be used.

Various embodiments can include a system including one or more processors; and one or more non-transitory computer-readable media storing computing instructions, that when executed on the one or more processors, cause the one or more processors to perform certain acts. The acts can include obtaining a route plan for outbound transport from a distribution center. The acts also can include processing multiple threads in parallel to obtain multiple improvements to the route plan. Each of the multiple threads can customize the route plan using one or more different parameters. The acts additionally can include selecting a lowest cost route solution from the multiple improvements to the route plan. The acts also can include using the lowest cost route solution for the outbound transport from the distribution center.

A number of embodiments can include a method being implemented via execution of computing instructions configured to run on one or more processors and stored at one or more non-transitory computer-readable media. The method can include obtaining a route plan for outbound transport from a distribution center. The method also can include processing multiple threads in parallel to obtain multiple improvements to the route plan. Each of the multiple threads can customize the route plan using one or more different parameters. The method additionally can include selecting a lowest cost route solution from the multiple improvements to the route plan. The method also can include using the lowest cost route solution for the outbound transport from the distribution center.

Although automatically determining improved route plans by running multiple threads in parallel for each stage of route construction has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-6 may be modified, and that the foregoing discussion of certain of these embodiments does not necessarily represent a complete description of all possible embodiments. For example, one or more of the procedures, processes, or activities of FIGS. 3-6 may include different procedures, processes, and/or activities and be performed by many different modules, in many different orders, and/or one or more of the procedures, processes, or activities of FIGS. 3-6 may include one or more of the procedures, processes, or activities of another different one of FIGS. 3-6. Additional details regarding multi-threading route planner system 300, algorithm system 311, splitting system 312, route improving system 313, communication system 314, constructing system 315, processing system 316, and/or feasibility check system 317, (see FIGS. 3 and 6) can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents

What is claimed is:

1. A system comprising:
one or more processors; and
one or more non-transitory computer-readable media storing computing instructions, that when executed on the one or more processors, cause the one or more processors to perform functions comprising:
obtaining a route plan for outbound transport from a distribution center;
processing multiple threads in parallel to obtain multiple improvements to the route plan, where each of the multiple threads customizes the route plan using one or more different parameters;
selecting a lowest cost route solution from the multiple improvements to the route plan; and
using the lowest cost route solution for the outbound transport from the distribution center.

2. The system of claim 1, wherein processing the multiple threads to obtain the multiple improvements to the route plan comprises:
using a metaheuristic search method comprising a Tabu search.

3. The system of claim 1, wherein obtaining the route plan comprises:
constructing the route plan for a dry trailer based on a loading plan.

4. The system of claim 3, wherein constructing the route plan for a dry trailer based on a loading plan further comprises:
constructing the multiple improvements to the route plan for the dry trailer using the one or more different parameters for each of the multiple threads.

5. The system of claim 1, wherein processing the multiple threads to obtain the multiple improvements to the route plan further comprises:
splitting, using a Tabu search, the one or more different parameters for each of the multiple threads; and
tuning, by the Tabu search, the one or more different parameters for each of the multiple threads by varying a Tabu list size.

6. The system of claim 1, wherein:
the one or more different parameters comprise at least one of:
a weight of miles;
a weight of routes; or
a weight of stops.

7. The system of claim 1, wherein obtaining the route plan comprises:
constructing the route plan for a temperature-controlled trailer based on a loading plan for orders, wherein the orders comprise refrigerated pallets and frozen pallets.

8. The system of claim 7, wherein constructing the route plan for the temperature-controlled trailer further comprises:
splitting each of the orders according to a temperature range for transport in the temperature-controlled trailer; and
constructing, using a greedy heuristic, the route plan for the temperature-controlled trailer.

9. The system of claim 8, wherein processing the multiple threads to obtain the multiple improvements to the route plan further comprises:
constructing the multiple improvements to the route plan for the temperature-controlled trailer using the one or more different parameters for each of the multiple threads;
splitting, using a Tabu search, the one or more different parameters for each of the multiple threads; and
tuning, by the Tabu search, the one or more different parameters for each of the multiple threads by varying a Tabu list size,
wherein the one or more different parameters for the temperature-controlled trailer comprise at least one of:
a weight of miles;
a weight of routes; or
a weight of stops.

10. The system of claim 1, wherein selecting the lowest cost route solution comprises:
conducting multiple feasibility checks for each of the multiple improvements to the route plan, wherein the multiple feasibility checks comprise:
a load feasibility check, a route feasibility check, and an hours of service (HOS) feasibility check.

11. A method being implemented via execution of computing instructions configured to run on one or more processors and stored at one or more non-transitory computer-readable media, the method comprising:
obtaining a route plan for outbound transport from a distribution center;
processing multiple threads in parallel to obtain multiple improvements to the route plan, where each of the multiple threads customizes the route plan using one or more different parameters;
selecting a lowest cost route solution from the multiple improvements to the route plan; and
using the lowest cost route solution for the outbound transport from the distribution center.

12. The method of claim 11, wherein processing the multiple threads to obtain the multiple improvements to the route plan comprises:
using a metaheuristic search method comprising a Tabu search.

13. The method of claim 11, wherein obtaining the route plan comprises:
constructing the route plan for a dry trailer based on a loading plan.

14. The method of claim 13, wherein constructing the route plan for a dry trailer based on a loading plan further comprises further comprises:
constructing the multiple improvements to the route plan for the dry trailer using the one or more different parameters for each of the multiple threads.

15. The method of claim 11, wherein processing the multiple threads to obtain the multiple improvements to the route plan further comprises:
splitting, using a Tabu search, the one or more different parameters for each of the multiple threads; and
tuning, by the Tabu search, the one or more different parameters for each of the multiple threads by varying a Tabu list size.

16. The method of claim 11, wherein:
the one or more different parameters comprise at least one of:
a weight of miles;
a weight of routes; or
a weight of stops.

17. The method of claim 11, wherein obtaining the route plan comprises:
constructing the route plan for a temperature-controlled trailer based on a loading plan for orders, wherein the orders comprise refrigerated pallets and frozen pallets.

18. The method of claim 17, wherein constructing the route plan for the temperature-controlled trailer further comprises:
splitting each of the orders according to a temperature range for transport in the temperature-controlled trailer; and
constructing, using a greedy heuristic, the route plan for the temperature-controlled trailer.

19. The method of claim 18, wherein processing the multiple threads to obtain the multiple improvements to the route plan further comprises:
constructing the multiple improvements to the route plan for the temperature-controlled trailer using the one or more different parameters for each of the multiple threads;
splitting, using a Tabu search, the one or more different parameters for each of the multiple threads; and
tuning, by the Tabu search, the one or more different parameters for each of the multiple threads by varying a Tabu list size,
wherein the one or more different parameters for the temperature-controlled trailer comprise at least one of:
a weight of miles;
a weight of routes; or
a weight of stops.

20. The method of claim 11, wherein selecting the lowest cost route solution comprises:
conducting multiple feasibility checks for each of the multiple improvements to the route plan, wherein the multiple feasibility checks comprise:
a load feasibility check, a route feasibility check, and an hours of service (HOS) feasibility check.
